(19) United States
(12) Patent Application Publication
(10) Pub. No.: US 2010/0126987 A1
(43) Pub. Date: May 27, 2010

(54) Device for transfer of microwave energy into a defined volume

(76) Inventors: Valerie S. Zhylkov, Kharkov (UA); Stanislav V. Zhilkov, Philadelphia, PA (US); James Hayden Brownell, Wilmington, DE (US)

Correspondence Address: Albert T. Keyack, PO Box 439039, San Diego, CA, 92143, US

(21) Appl. No.: 12/313,806

(22) Filed: Nov. 25, 2008

(51) Int. Cl. H05B 6/64

(52) U.S. Cl. 219/690; 219/756

(57) ABSTRACT

A planar antenna device that transfers microwave energy from generator into a separate defined volume is disclosed. Device having a single-disk radiator with diameter of 0.95-1.45 half-wavelengths provides both uniformity over 90% in rectangular chamber and acceptable value of SWR (standing wave ratio) if tuned for specific microwave generator. Device having a poly-disk radiator with diameter of 0.95-1.45 half-wavelengths provides both uniformity over 90% in rectangular chamber and acceptable value of SWR for whole industrial frequency band without additional tuning/s.

### FIELD OF THE INVENTION

The present invention relates to the field of planar antenna devices that transfer microwave energy into a separate volume of interest, which may be open space, a wave-guiding structure, or a closed chamber. The devices disclosed are preferably used in the field of microwave power applications, specifically for providing spatial uniformity of electromagnetic energy density in processing chambers irradiated with microwaves by means of a planar antenna device. Applications of the invention include the electromagnetic heating of foods and other materials, etching of semiconductor devices in plasma reactors, chemical and biochemical processing including synthesis of pharmaceutical compounds, optimizing fuel production, producing ceramics, curing epoxy and composite materials, and other microwave-enhanced material processing

### State of the Art

Planar antenna devices for microwave band have been known in the art since the 1950s. For decades, these types of antennae have been used for transmitting and receiving microwave signals to transfer information in communications, navigation and for other informational purposes. However, until recently, planar antennas were not used in high power delivery applications such as heating, accelerating chemical reactions and enhancing other material processing.

U.S. Pat. No 4,695,693 entitled “Triangular antenna array for microwave oven,” to Staats et al. (1987), discloses a planar antenna proposed for microwave energy processing application (in a food processor). The Staats patent proposes embedding a thin planar antenna within a massive dielectric slab. Such a design, with dielectric surrounding the planar metal antenna, is not appropriate for high-power, or high-temperature, or contamination-sensitive applications such as chemical processing because the dielectric traps enough energy to cause destructive heating.

Recently, planar antennas without destructible dielectric parts have been being considered for the transfer of high levels of microwave energy into processing chambers for different applications. A series of recent patents to V. Zhylkov (Patents of Russia Nos. 2085057 of Jan 1997, 2124278 of Dec 1998; 2149520 of May 2000; 2257018 of July 2005 and 2273117 of March 2006) disclose planar antenna devices appropriate for high-power use.

There are two features that are important to satisfactory operation in high power material processing applications: uniform distribution of microwave energy in the chamber and stability of processing over a sufficiently wide frequency band. Achieving both features simultaneously is a notoriously difficult problem when the chamber has dimensions comparable to the radiation wavelength; this particular problem has not been sufficiently resolved until now. For example, a simple planar disk radiator has been recently proposed to transfer the microwave energy into processing chamber, as seen in the above-noted Patent of Russia No. 2124278 (1998). However, even in the simple disk case, there are critical parameters affecting performance that were not understood at that time this patent was published. Specifically, it was not known how to achieve uniform distribution simultaneously with broad frequency band stability. It is therefore an object of the present invention to provide designs of antennas for use in high power microwave applications that provide both uniform power distribution and which are useful over a broad band of the frequency spectrum.

### SUMMARY OF THE INVENTION

Among the above-mentioned critical parameters, the disk diameter has a unique set of values within a limited range that optimizes the uniformity of the field energy distribution in a multi-mode chamber having dimensions comparable with operational wavelength. Until recently, there has been no methodology for properly selecting the disk diameter. Now it has been found that semi-empirical formulae, covering the disk design, can be derived from experimental results. Said formulae guide how a planar antenna should be designed to provide maximum uniformity of the microwave energy distribution inside a processing chamber. These formulae form part of the present invention.

As used herein, “uniformity” is most preferably determined in accordance with the International Standard IEC 60705, Edition 3.2, 2006-03, “Household microwave ovens—Methods for measuring performance.” For most applications, higher uniformity improves the predictability, quality and yield of the processed product.

Also, it is critically important to provide a stability of planar device operation exceeding the frequency range of microwave generators used. This generator frequency range is the result of two sources: operating frequency drift of a given generator due to variable operating conditions and the variation in central operating frequency of a commercial generator series due to variable manufacturing conditions. For example, for nominal 2,450 MHz magnetron generators the typical frequency drift is +10 MHz relative to its central operating frequency and the central frequency varies by ±50 MHz. In accordance with the present invention, a single-disk planar device satisfies the critical requirement of band stability over the typical frequency drift of a commercial magnetron. This device can be tuned to cover the 24 MHz drift band of any particular commercial magnetron in the 2 400 MHz to 2 500 MHz industrial band.

While the configurations disclosed provide vast improvements over pervious microwave transfer apparatus designs, the are not fully satisfactory because the generator needs to be replaced regularly. The replacement generator would not likely operate within the same narrow frequency band as generator that was replaced and so re-tuning of the planar device is required to provide effective operation. Therefore, a planar device design with frequency band of stability exceeding the frequency range of microwave generators used would be beneficial because it would not require re-tuning. As discussed in detail below, certain embodiments of the present invention include a poly-disk planar device that satisfies the critical requirement of band stability over the entire 100 MHz range of a commercial magnetron production series.

### BRIEF DESCRIPTION OF THE DRAWINGS

FIG. 1 is a graph of the characteristics of a single-disk module optimized for operation at frequencies between 2,430 to 2,455 MHz;

FIG. 2a-2b is a diagram of a microwave power module with double-disk radiator made in accordance with the present invention;

FIG. 2c is a graph of SWR for frequencies generated using the device shown in FIGS. 2a-2b;

FIGS. 3a-3b are, respectively, a side elevation view and a plan view of a planar antenna with a triple-disk radiator made in accordance with the present invention; and

FIG. 3c is a graph of SWR for frequencies generated using the device shown in FIGS. 2b and 3a.

### DETAILED DESCRIPTION OF THE PREFERRED EMBODIMENTS

### Description of an Optimized Single Disk Device

The present invention provides a device for transfer of microwave energy into processing chamber. In a preferred embodiment, the device contains a wave-guiding member, a connecting member and a radiating member. The wave-guiding member provides the delivery of microwave energy from the generator to the connecting member. The wave-guiding member may be a coaxial cable, a metal waveguide, a micro-strip line, or some combination of wave-guiding means known in the art. The connecting member provides both mechanical and electromagnetic contact between wave-guiding member and radiating member. The contact is provided in some known manner, as “coaxial to planar antenna” transition, for example. The radiating member includes a radiator and a screen, which are positioned with a certain gap between them. Preferably, the radiator is a thin, flat plate that made of material with good electric conductivity as aluminum, copper, or other metal or alloy of metals. The flat screen is approximately parallel to the radiator's plate. In area and positioning, said screen may overlap the radiator. The gap h between a radiator and a screen may be in the range

0.01λ=h=0.25λ, where

λ is a wavelength in free space and λ corresponds to the central operating frequency of radiation.

### Optimization of Single-element Planar Radiator Design

In accordance with certain aspects of the invention, a single-element planar radiator device contains a radiator plate that may have a shape of ellipse, or symmetrical simply-connected polygon, or asymmetrical simply-connected polygon, or other simply-connected figure where “simply-connected” means every pair of points in the figure can be connected by a straight line segment that is wholly within the figure perimeter. The radiator is preferably essentially flat and thin, i.e., planar. Because electromagnetic theory scales with wavelength, define the normalized radiator area as:

A=(L×λ/2)×(W×λ/2)=(L×W)×λ²/4, where

λ is a wavelength in free space corresponding to the central operating frequency;

L is the largest dimension of the radiator normalized with respect to the half wavelength;

W is the normalized width of the radiator calculated in integral form as the ratio of the radiator area to its largest dimension;

The characteristic parameters {L; W} of the radiator shall be selected so that to provide the most uniform electromagnetic energy density distribution within the camber volume. The dimensions and shape of the radiator shall be so that the area of said radiator's emitting surface satisfies the following inequality:

(L×W)=0.3

In other words, the area shall not be less than 7.5% of a square wavelength. The thickness of the radiator shall be small compared to one half of the wavelength.

The classical linear half-wavelength dipole represents a limiting case. The largest dimension is equal to λ/2, so that the normalized length is L=1 and normalized width W is tending to zero. It is well known that in a rectangular chamber of volume equal to a few tens of cubic wavelengths, the dipole typically excites not more than six spatial modes and uniformity of distribution of microwave energy not exceeding 60% (as measured with an array of beakers of water on a rotating platform as specified by the IEC standard).

An equilateral triangle, as one example, has a weight coefficient W=0.433 (ratio of half-height to side). In optimal case, a linear coefficient is in the range 0.95=L=1.65. The optimized triangle radiator produces ten spatial modes in representative rectangular chamber with uniformity of distribution of microwave energy near 72% (measured with an array of beakers of water on a rotating platform as specified by standard IEC standard).

A square-shaped radiator, as another example, has a weight coefficient W=0.5 (ratio of area to diagonal squared). If optimized, a linear coefficient is in the range 0.95=L=1.55. The optimized square-shaped radiator has experimentally demonstrated excitation of twelve spatial modes in the representative rectangular chamber with uniformity of distribution of microwave energy near 88% (measured with an array of beakers of water on a rotating platform as specified by standard IEC standard).

A simple circular disk has a weight coefficient W=0.785 (ratio of area to diameter squared). If optimized, a linear coefficient is in the range 0.95=L=1.45. The optimized circular disk radiator shall have diameter D in the range 0.95(λ/2)=D=1.45(λ/2). The radiator with diameter in this range has been experimentally found as most efficient in terms both of the number of excited spatial modes and uniformity of distribution of microwave energy in the representative rectangular chamber (94% measured with an array of beakers of water on a rotating platform as specified by standard IEC standard).

For any one of the FCC-approved industrial frequency bands, the preferred disk radiator shall have a diameter of value D in the range specified by the inequality disclosed in current section, while the wavelength X shall correspond to a central frequency of the band considered.

In particular, for industrial frequency band 2 450±50 MHz, the preferred disk radiator has a diameter in the range from 5.8 cm=D=6.7 cm.

### Poly-disk Embodiments

A standing wave ratio (SWR) is a parameter that quantifies an efficiency of matching a generator with a chamber. SWR is typically analyzed in specific range of microwave frequencies. The matching is achieved if the desired SWR is confirmed for all frequencies in the required operating range. Matching improves as the SWR approaches an ideal value of one.

For most purposes of microwave (MW) power engineering (power transfer for applications such as heating or other processing in a chamber), a value of SWR below 2.0 is required. In some cases of MW power engineering, such as food preparation, it is acceptable to operate with load in a chamber under condition of SWR up to 4.0 (as in the majority of consumer microwave ovens).

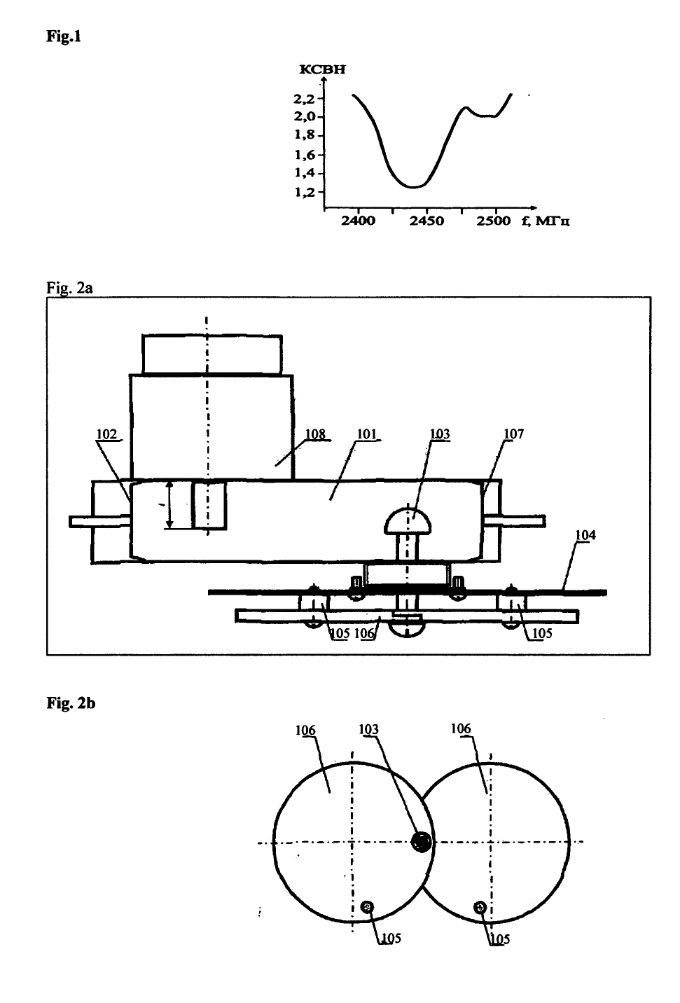

A MW power module has been described for matching of generator and chamber. This module comprises an adaptation waveguide, coaxial connector and planar antenna with a radiator as simple circular disk having diameter close to half-wavelength of free space radiation. Adjustment of a plunger, a trombone and a tuning screw is performed in an adaptation waveguide to reach a minimal value of SWR while emitting into free space. The adjusting leads to optimal tuning of a module with single-disk planar antenna. FIG. 1 demonstrates characteristics of a module that has been specifically optimized for operation at frequencies within the range from 2,430 to 2,455 MHz. As seen in FIG. 1, for a free space emitting device the horizontal axis shows the frequency in MHz; the vertical axis shows the SWR. (In the adaptation waveguide, SWR is measured in voltage domain according to standard procedures. Output arrangement is considered as a load, the tuning means are adjusted to minimize the SWR. Information is taken from co-pending US Patent Application “Method for optimal matching of microwave source with irradiated volume and a microwave power modular device” Ser. No. ______, which is hereby incorporated by reference.)

If emitting into a free space, the above-mentioned tuned module provides the value of SWR below 1.35 in the band having width of 25 MHz, which exceeds an operating frequency range of a nominal 2,450 MHz generator that is typically exploited in microwave power processor as consumer oven. This 25 MHz bandwidth is enough for stability of processing, because during processing the operating frequency of such a generator shifts less than 0.5% or 10 MHz from its central frequency. Therefore, if a generator is selected to have its central frequency to be f=2,442 MHz (as in shown example), then said single-disk planar antenna is sufficiently broadband to cover possible drift in operating frequency of this generator during processing. However, the single-disk planar antenna that known in the art is not sufficiently broadband to cover, without additional tuning, the entire range of frequencies from 2,400 to 2,500 MHz typical to industry standard.

Another MW power system, described in the art, comprises an array of four disk antennae emitting into a chamber, as shown in Russian Patent No. 2257018. It is well known that an optimally formed array may cover a broader range of frequencies than just single antenna element. However, tuning of array in effect requires simultaneous manipulations with all antennas according to a complicated procedure. (An appropriate procedure is disclosed, for example, in co-pending U.S. patent application Ser. No. ______, entitled “Method for treating a material by microwaves and apparatus for microwave processing”, which is hereby incorporated by reference.)

It is therefore an objective of the poly-disk embodiments of the invention to provide a new system that combines both the simplicity of tuning of single-disk narrow band MW module and a broadband matching ability of array of several separate disk antennas.

This aspect of the present invention is demonstrated by the embodiments described in detail below. Simply stated, it is proposed to attach several disks to each other for forming so-called “poly-disk radiator”. The poly-disk radiator is mechanically and electrically connected to a screen by central rod of coaxial connector. The point of contact of said connector to said radiator is preferably in close proximity to the geometrical center of symmetry of the radiator. In addition, the poly-disk radiator is mechanically and electrically connected to the screen by the metallic joint/s preferably located in close proximity to outer circle of “elemental” disk/s. Optimal positioning of all points of contacts between a radiator and a screen, including the points of contact of all coaxial rod and joint/s, is experimentally selected so that the complete arrangement provides a minimal value of SWR over the broadest band of frequencies.

Preferred embodiments of the present invention have shown that for a poly-disk radiator, after its optimization and constant fixing, the value of SWR is acceptable for microwave power applications over the entire industrial band of frequencies from 2 400 MHz to 2 500 MHz, without further additional tuning.

### Poly-disk Preferred Embodiments

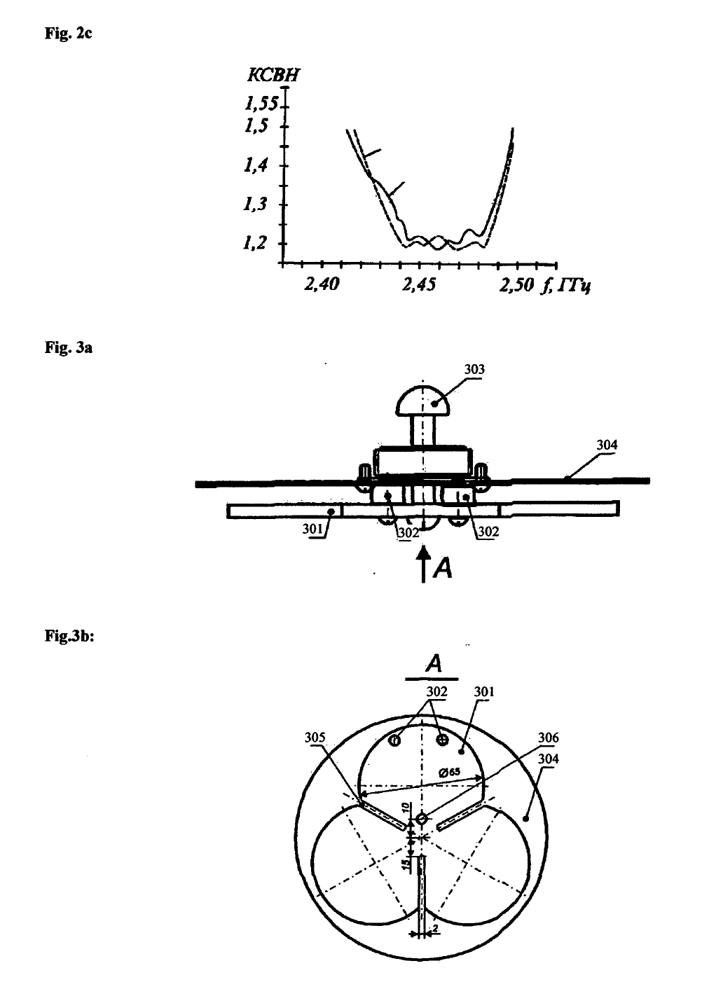

The present invention includes embodiments in which two or more disks or antenna structures of any shape may be combined in a single device. For one example, a MW power module that includes a double-disk planar antenna is shown in FIGS. 2a and 2b, which illustrates a general view of MW power module with double-disk radiator 200. As shown, an adaptation waveguide 201 is preferably about 90×37 mm. The module also includes tuning plungers 202,207 and coaxial connector 203, as well as a metallic screen 204. The device preferably has two metallic joints 205 joining a screen to a radiator formed by two disks 206. The magnetron 208 is also shown in this view. The discs forming a planar radiator are of diameter of about 6.1 cm in a preferred embodiment.

For two modifications of double-disk antennas, FIG. 2c illustrates graphs of SWR for frequencies in the band (2.40-2.50) GHz. (Modifications No. 1 and No. 2 have different positioning of metallic joints. No. 1 corresponds to positioning, when joints are located in different “elemental” disks. No. 2 corresponds to positioning, when both joints are located within the same “elemental” disk. Every scenario assumes that joints are in close proximity to the outer circle of “elemental” disk/s and specific positions of the joint are experimentally selected to produce a minimal value of SWR). In FIG. 2c, for a free space emitting device, the horizontal axis shows the frequency in GHz; vertical axis shows the SWR. (As known in the art, in an adaptation waveguide, SWR is measured in the voltage domain according to standard procedures. The output arrangement is considered as a load, and the tuning means are adjusted to minimize the SWR). It has been experimentally found that both optimized modifications have a value of SWR not exceeding 1.55 in the band with width of about 100 MHz, which covers the entire industrial frequency range of 2 450±50 MHz.

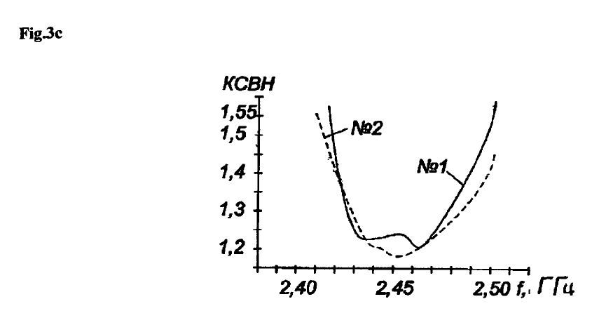

The present invention also includes an embodiment, which is a triple-disk planar device for transfer of MW energy in a processing chamber. A side elevation view of a matching device with a triple-disk radiator is shown in FIGS. 3a. In FIG. 3a the planar antenna with a triple-disk radiator preferably includes a triple-disk radiator 301, two metallic joints 302, a coaxial connector 303, a metallic screen 304.

As seen in the view of the planar antenna with triple-disk radiator shown in FIG. 3b, there is a triple-disk radiator 301, two metallic joints 302, a coaxial connector 303, a metallic screen 304, three slots 305, and a point of contact 306 of the radiator 301 to the central rod of coaxial connector 303. The “elemental” disks have a diameter of 65 mm and the slots have a width of 2 mm in a preferred embodiment of triple-disk radiator.

For two modifications of triple-disk antennas, the FIG. 3c illustrates graphs of SWR for frequencies in the band (2.40-2.50) GHz. (Modifications No. 1 and No. 2 have different positioning of metallic joints. No. 1 corresponds to positioning, when joints are located in different “elemental” disks. No. 2 corresponds to positioning, when both joints are located within the same “elemental” disk. Every scenario assumes that joints are in close proximity to the outer circle of “elemental” disk/s and specific positions of the joints are experimentally selected to produce minimal value of SWR).

For the free space emitting device illustrated by the graph in FIG. 3c, the horizontal axis shows the frequency in GHz; vertical axis shows the SWR (In the adaptation waveguide, SWR is measured in voltage domain according to standard procedures. The output arrangement is considered as a load, the tuning means are adjusted to minimize the SWR). It has been experimentally found that optimized modification No. 2 has a value of SWR not exceeding 1.5 in the band with width of ˜100 MHz, which covers an entire industrial frequency range 2 450±50 MHz.

Further experiments with double-disk and triple-disk planar devices have demonstrated that required matching is provided for rather different loads arbitrary positioned in a typical rectangular chamber of volume of a several tens of cubic wavelengths. The value of SWR, measured with said plurality of loads, does not exceed 2.0, which is acceptable for microwave power applications. Both for double-disk and triple-disk, the uniformity over 90% and the stable operation in 100MHz-band have been confirmed experimentally.

In general, it is preferred that the radiator is comprised of a flat plate that contains two or more elemental parts. At that, every one of said elemental parts has a shape of a so-called simply-connected figure. As used herein, the term “simply-connected” means that every pair of points in the figure can be connected by a straight line segment that is wholly within the figure perimeter, such as for example an ellipse, a symmetrical simply-connected polygon, or an asymmetrical simply-connected polygon.

While the invention has been shown and described with respect to the preferred embodiments, it will be understood by those skilled in the art that various changes and modifications may be made without departing from the spirit and scope of the invention as defined in the following claims, including, but not limited, for example, a case of covering of radiator by some dielectric material with proper changes of dimensions of all geometrical parts proportionally to dielectric constant of said material.

What is claimed is:

1. A device for transfer of high microwave power into a separate volume of interest, which may be open space, a wave-guiding structure, or a chamber loaded with possibly material for heating or other processing, said device comprising a wave-guiding member, a connecting member and a radiating member;
said wave-guiding member delivers microwave energy from external generator to a connecting member;
said connecting member provides both mechanical and electromagnetic contact between said wave-guiding member and a radiating member;
said radiating member emits microwaves into a separate volume which may open space, a wave-guiding structure, or closed chamber,
wherein said radiating member includes a radiator and a screen, which are positioned with a certain gap between them,
wherein said radiator may be a thin, flat plate made of material with good electric conductivity as aluminum, or copper, or other metal,
while said device is tuned for stable operation in certain frequency band as demonstrated by value of SWR below maximally-acceptable limit in said band
while transfer of microwaves by said device leads to uniform distribution of microwave energy density in said processing chamber with coefficient of uniformity exceeding a minimally-acceptable value for said processing

2. A device as claimed in claim 1, wherein a radiating member includes a radiator as flat metal plate said plate may have a shape of ellipse, or symmetrical simply connected polygon, or asymmetrical simply connected polygon, or other figure where every pair of points in the figure can be connected by a straight line segment that is wholly within the figure perimeter,
while a largest dimension of said plate may be approximately equal to or greater than half of lambda,
while an area of surface of said plate may be approximately equal to or greater than one tenth of a square with side of length equal to lambda (λ),
while said lambda (λ) is free space wavelength that corresponds to central frequency of operational band of radiation applied.

3. A device as claimed in claim 1, wherein a radiating member includes a radiator as flat metal plate and a screen as flat metal plate, wherein the screen's plate is substantially parallel to a radiator's plate, and wherein the radiating member includes a radiator and a screen, having an area and positioning in which said screen may overlap said radiator.

4. A device as claimed in claim 3, wherein a gap between a radiator and a screen is from about one hundredth of a wavelength (lambda) to about one quarter of a wavelength (lambda).

5. A device as claimed in claim 2, wherein said device includes a radiator as flat metal plate with a shape that characterized by parameters L, W and T, wherein:
L is a linear coefficient characterizing the largest dimension of said plate with respect to half-lambda; so L is so-called normalized length of the radiator;
W is a weight coefficient that equals to ratio of average value of width of said plate's surface to its largest dimension; said average value is determined in the direction that perpendicular to the largest dimension line; said average value is calculated in integral form as ratio of said plate surface's area to said plate surface's largest dimension; and so W is so-called normalized width of the radiator;
T is a linear coefficient characterizing the thickness of said plate with respect to half-lambda; so T is so-called normalized thickness of the radiator;
whereby three characteristic parameters {L; W; T } of the radiator shall be selected to provide the most uniform electromagnetic energy density distribution within said chamber volume.

6. A device as claimed in claim 1, wherein said radiator has a thickness that is small compared to half of the wavelength.

7. A device as claimed in claim 2, said device includes a radiator as flat metal plate, said plate has a shape of circular disk, wherein the ratio of said disk's diameter D to half-lambda is in the range
0.95=D/(λ/2)=1.45

8. A device for transfer of high power microwave energy into a separate volume of interest, which may be open space, a wave-guiding structure, or a chamber loaded with possibly material for heating or other processing, for operation at industrial frequency band 2,450±50 GHz, said device comprising a wave-guiding member, a connecting member and a radiating member;
said wave-guiding member delivers microwave energy from external generator to a connecting member;
said connecting member provides both mechanical and electromagnetic contact between said wave-guiding member and a radiating member;
said radiating member emits microwaves into a separate volume which may open space, a wave-guiding structure, or closed chamber,
wherein said radiating member includes a radiator and a screen, which are positioned with a certain gap between them,
wherein said radiator is a flat plate that made of material with good electric conductivity as aluminum, or copper, or other metal,
wherein said plate has a shape of circular disk,
while said disk has a diameter in a range from 5.8 cm to 6.7 cm.

9. A device as claimed in claim 1, wherein flat plate of the radiator is a manifold of two or more elemental parts attached to each other through common overlapping geometrical region.

10. A device as claimed in claim 9, wherein each elemental part may have a shape of ellipse, or symmetrical simply connected polygon, or asymmetrical simply connected polygon, or other figure where every pair of points in the figure can be connected by a straight line segment that is wholly within the figure perimeter

11. A device as claimed in claim 9 wherein flat plate of said device's radiator may have slots.

12. A device as claimed in claim 9, wherein a largest dimension of every one of said elemental parts is approximately equal to or greater than half of the wavelength, lambda (α), and an area of surface of every one of said elemental parts is approximately equal to or greater than one tenth of a square with side of length equal to lambda (λ), and lambda (λ) is free space wavelength that corresponds to central frequency of operational band of radiation applied.

13. A device as claimed in claim 9, wherein a radiating member includes a radiator and a screen, while in area and positioning said screen may overlap said radiator.

14. A device as claimed in claim 9, wherein a gap between a radiator and a screen may be in a range from one hundredth to one quarter of lambda.

15. A device as claimed in claim 9, wherein the radiator's plate is a manifold of two or more elemental parts attached to each other through common overlapping geometrical region, while every elemental part is of area A in the range
0.1<A/(λ/2)²<0.45.

16. A device as claimed in claim 9, wherein the radiator's plate is a manifold of two or more elemental parts attached to each other through common overlapping geometrical region, while said overlapping geometrical region is of area S in the range
0.01<S/(λ/2)²<0.25.

17. A device as claimed in claim 9, wherein the radiator's plate is a manifold of two or more circular disks attached to each other through common overlapping geometrical region, while for every disk the ratio of said disk's diameter D to half-lambda is in the range
0.95=D/(λ/2)=1.45.

18. A device as claimed in claim 17, said device is for operation in industrial band of frequencies 2,450±50 MHz, wherein the radiator's plate is a manifold of two circular disks attached to each other through common overlapping geometrical region, while both disks are of the same diameter in the range from 5.8 cm to 6.7 cm.

19. A device as claimed in claim 17, said device is for operation in industrial band of frequencies 2,450±50 MHz, wherein the radiator's plate is a manifold of three circular disks attached to each other through common overlapping geometrical region, while all three disks are of the same diameter in the range from 5.8 cm to 6.7 cm.
